(19) United States
(12) Patent Application Publication
(10) Pub. No.: US 2012/0126458 A1
(43) Pub. Date: May 24, 2012

(54) CASTING MICROSTRUCTURES INTO STIFF AND DURABLE MATERIALS FROM A FLEXIBLE AND REUSABLE MOLD

(76) Inventors: William P. King, Champaign, IL (US); Andrew H. Cannon, Columbia, SC (US)

(21) Appl. No.: 13/322,437

(22) PCT Filed: Jul. 2, 2009
(86) PCT No.: PCT/US09/49565

§ 371 Date: Feb. 8, 2012

Related U.S. Application Data
(60) Provisional application No. 61/181,125, filed on May 26, 2009.

(51) Int. Cl. B29C 33/40; B29C 39/02; B29C 71/00; B29C 71/04; B22C 9/00; B22D 25/02

(52) U.S. Cl. 264/483; 164/6; 264/219; 264/405; 264/101; 164/15

(57) ABSTRACT

Described are methods for making microstructured flexible molds, for example useful for making microstructured metal objects in a casting process. Also described are casting methods for making microstructured epoxy objects. In some embodiments, the microstructured metal and epoxy objects are useful for embossing polymer sheets to form microstructured polymer sheets.

### CROSS REFERENCE TO RELATED APPLICATION

This application claims the benefit of and priority to U.S. Provisional Application 61/181,125 filed on May 26, 2009, which is hereby incorporated by reference in its entirety.

### BACKGROUND OF THE INVENTION

This invention is in the field of casting/molding techniques. This invention relates generally to methods of making molded or cast microstructured objects.

Casting and molding methods have long been utilized for producing and replicating objects. In general, the negative of an object is produced in a casting or molding process; that is, recessed features are replicated as raised features and vice versa. As such, at least two steps are generally required for replication of an object or features via casting or molding. First, a mold or form of an object is created around or on the master object, creating a negative of the master. For a casting method, the mold or form is filled with an end product material, creating a negative of the mold or form, which results in an end product having features which generally resemble those of the master. In molding and embossing methods, the mold or form is stamped or forced onto the end product material and the features of the master are replicated into the end product. Alternatively, the negative of the desired end product can be fabricated directly and used in a casting, molding or stamping process.

Only recently have casting and molding methods been applied to microstructured metal objects. International Patent Application Number PCT/US09/43306 filed on May 8, 2009, herein incorporated by reference in its entirety, describes sequential casting and molding methods for making rubber, ceramic, and metal microstructured objects. U.S. Pat. Nos. 7,141,812, 7,410,606, 7,411,204 and 7,462,852 disclose casting methods for making microstructured objects from molds comprising stacks of laminated layers.

U.S. Pat. No. 5,512,219 discloses a reusable polymeric mold for casting a plastic sheet of corner-cube type objects for retroreflecting applications. A metal layer is deposited onto an embossing mold and then a plastic compound and laminating film are applied to form a retroreflective sheet.

U.S. Pat. No. 5,055,163 discloses methods for making a nickel metal molding tool. An AlMg₃ master is patterned using a microdiamond and then a nickel layer is electroplated thereon. Also disclosed is a cylindrical copper mold having a patterned interior surface which is electroplated with nickel. Finally the AlMg₃ or copper is dissolved or etched away, leaving a nickel molding tool.

U.S. Patent Application Publication No. 2009/0046362 discloses roll-to-roll nano imprint lithography techniques for imparting features to a polymer substrate. International Patent Application Publication Nos. WO 2007/064803, WO 2008/098030 and WO 97/13633 and U.S. Pat. Nos. 7,144,241, 6,357,776 and 6,190,594 also disclose techniques for embossing or patterning substrate surfaces.

### SUMMARY OF THE INVENTION

Described herein are casting and molding methods useful for making microstructured metal, polymer and epoxy objects. By including a plurality of microfeatures on the surface of an object, other characteristics may be imparted to the object, such as increased hydrophobicity. Some of the cast objects described herein further allow for manufacture of objects in roll to roll embossing methods.

In a first aspect, provided are methods for making microstructured metal objects. A method of this aspect comprises the steps of: fabricating a microstructured flexible mold having a preselected pattern of microfeatures on at least a portion of a surface of the microstructured flexible mold; applying a liquid metal having a melting point selected within the range of 35 to 650° C. to the microstructured flexible mold; cooling the liquid metal, thereby replicating at least a portion of the preselected pattern of microfeatures in solid metal; and removing the microstructured flexible mold from the solid metal, thereby making a microstructured metal object. In an exemplary embodiment, the microstructured flexible mold is heated to a temperature above the melting point of the metal. In a specific embodiment, at least a portion of the microfeatures of the microstructured flexible mold are replicated in the microstructured metal object with high fidelity. In some embodiments, the liquid metal has a melting point selected between 50° C. and 500° C., for example a melting point selected between 60° C. and 300° C. or between 70° C. and 150° C.

For some embodiments, the methods of this aspect further comprise a step of applying pressure between the liquid metal and the microstructured flexible mold. For example, when the contact angle between the liquid metal and the microstructured flexible mold is greater than 90°, pressure is optionally applied between the liquid metal and the microstructured flexible mold.

For some embodiments, the methods of this aspect further comprise a step of placing the liquid metal and microstructured flexible mold under vacuum. For example, the liquid metal and the microstructured flexible mold are optionally placed under vacuum before the liquid metal is cooled and/or solidified. For other embodiments, the methods of this aspect further comprise a step of placing the liquid metal and microstructured flexible mold under a pressure greater than ambient pressure. For example, the liquid metal and the microstructured flexible mold are optionally placed under a pressure greater than ambient pressure before the liquid metal is cooled and/or solidified.

In embodiments, the metal comprises lead, tin, bismuth, cadmium, indium, antimony, iron, nickel, cobalt, zinc, aluminum, gold, silver, copper, platinum, tungsten, tantalum or any combination or alloy of these. In specific embodiments, the metal comprises an alloy selected from the group consisting of: CerroMatrix® (Bismuth-Lead-Tin-Antimony alloy), CerroCast® (Bismuth-Tin alloy), CerroTru® (Bismuth-Tin alloy), CerroBase® (Bismuth-Lead alloy), CerroLow® 136 (Bismuth-Lead-Tin-Indium alloy), CerroBend® (Bismuth-Lead-Tin-Cadmium alloy), CerroSafe® (Bismuth-Lead-Tin-Cadmium alloy), CerroLow® 117 (Bismuth-Lead-Tin-Cadmium-Indium alloy), CerroLow® 147 (Bismuth-Lead-Tin-Cadmium-Indium alloy) and any combination of these.

In a second aspect, provided are methods for making a microstructured epoxy object. A method of this aspect comprises the steps of: fabricating a microstructured flexible mold having a preselected pattern of microfeatures on at least a portion of a surface of the microstructured flexible mold; applying a liquid thermoset polymer to the microstructured flexible mold; curing the liquid thermoset polymer, thereby replicating at least a portion of the preselected pattern of microfeatures in cured epoxy; and removing the microstructured flexible mold from the cured epoxy, thereby making a microstructured epoxy object. In a specific embodiment, at least a portion of the microfeatures of the microstructured flexible mold are replicated in the microstructured epoxy object with high fidelity.

For some embodiments, the methods of this aspect further comprise a step of applying pressure between the liquid thermoset polymer and the microstructured flexible mold. For some embodiments, the methods of this aspect comprise a step of placing the liquid thermoset polymer and the microstructured flexible mold under vacuum. For some embodiments, the methods of this aspect further comprise a step of releasing the vacuum before the curing step is finished.

In certain embodiments, an epoxy and/or a thermoset polymer comprise a two-part thermoset polymer mixture. Useful thermoset polymers include, but are not limited to: polyamides, polyimides, polyesters, phenol-formaldehydes, urea-formaldehydes, melamines, polyvinylchlorides, polyurethanes, silicone rubbers and any combination of these or other thermoset polymers known in the art.

In a third aspect, provided are methods for making a microstructured film. A method of this aspect comprises the steps of: fabricating a microstructured flexible mold having a preselected pattern of microfeatures on at least a portion of a surface of the microstructured flexible mold; applying a liquid metal having a melting point selected within the range of 35 to 650° C. or a liquid thermoset polymer to the microstructured flexible mold; cooling the liquid metal or curing the liquid thermoset polymer, thereby replicating at least a portion of the preselected pattern of microfeatures in solid metal or epoxy; and removing the microstructured flexible mold from the solid metal or epoxy, thereby making a microstructured embossing tool having the preselected pattern of microfeature on at least a portion of a surface of the microstructured embossing tool; providing a film; and embossing the film with the microstructured embossing tool, thereby making a microstructured film.

In a specific embodiment, at least a portion of the preselected pattern of microfeatures of the microstructured flexible mold is replicated in the microstructured embossing tool with high fidelity. In a specific embodiment, at least a portion of the preselected pattern of microfeatures of the microstructured embossing tool is replicated in the microstructured film with high fidelity.

Without wishing to be bound by any particular theory, there can be discussion herein of beliefs or understandings of underlying principles relating to the invention. It is recognized that regardless of the ultimate correctness of any mechanistic explanation or hypothesis, an embodiment of the invention can nonetheless be operative and useful.

### BRIEF DESCRIPTION OF THE DRAWINGS

FIG. 1 provides an overview of a casting process embodiment.

FIGS. 2A and 2B provide images of microcast epoxies.

FIG. 3 provides an overview of a method for making a microstructured flexible mold embodiment.

FIG. 4 provides an overview of a method for making a microstructured flexible mold embodiment and use of the microstructured flexible mold in a casting process embodiment.

FIG. 5 provides an overview of an embossing method embodiment.

FIG. 6 illustrates an embodiment for microcasting metal.

FIG. 7 provides images of microcast metal.

FIG. 8 provides images of microstructured silicone.

FIG. 9 provides images of microstructured cast metal.

FIG. 10 provides images of the sidewall of A) a silicone micropillar and B) metal microholes cast from silicone micropillars.

FIG. 11 illustrates an embodiment of an embossing method.

FIG. 12 provides images of A) silicone embossed by a microstructured metal and B) water droplets on flat and microstructured silicone.

FIG. 13 illustrates an embodiment of a casting method for making a microstructured metal roller.

FIG. 14 provides images of a microstructured metal roller.

### DETAILED DESCRIPTION OF THE INVENTION

In general the terms and phrases used herein have their art-recognized meaning, which can be found by reference to standard texts, journal references and contexts known to those skilled in the art. The following definitions are provided to clarify their specific use in the context of the invention.

“Unitary”, “unitary body” and “monolithic” refer to objects or elements of a single body of the same material.

“Microfeatures” and “microstructures” refers to features, on the surface of an object or mold, having an average width, depth, length and/or thickness of 100 μm or less or selected over the range of 10 nm to 100 μm, for example 10 nm to 10 μm or 10 nm to 1 μm. In some embodiments, microfeatures include relief features. In some embodiments, microfeatures include recessed features.

“Microstructured object” refers to an object having a plurality of microfeatures. Specific microstructured objects include microstructured prototypes, microstructured rubbers, microstructured ceramics, microstructured metals and microstructured end products.

“Preselected pattern” refers to an arrangement of objects in an organized, designed, or engineered fashion. For example, a preselected pattern of microstructures can refer to an ordered array of microstructures. In an embodiment, a preselected pattern is not a random and/or statistical pattern.

“Casting” refers to a manufacturing process in which a liquid material or a slurry is poured or otherwise provided into, onto and/or around a mold or other primary object, for example for replicating features of the mold or primary object to the cast material. Casting methods typically include a cooling or curing process to allow the cast material and/or precursor material to set and/or become solid or rigid. Some casting methods also include a final sintering, firing or baking step to cure a “green” or not finally cured object. For some casting methods, features of the mold or primary object are incorporated in the cast material as it sets. In specific embodiments, materials such as polymers and/or metals are cast from molds or primary objects which are compatible with the liquid or slurry material; that is, the molds or primary objects do not deform, melt, and/or are not damaged when brought into contact with the liquid or slurry material.

“Molding”, “stamping” and “embossing” refer to a manufacturing process in which a material is shaped or forced to take a pattern using a rigid mold or other primary object. Molding methods typically include placing the mold or primary object in contact with the material to be molded and applying a force to the mold, primary object and/or material to be molded. For some molding methods, features of the mold or primary object are replicated in the material to be molded during the molding process. In a specific embodiment, an end product, such as polymer, is molded from a patterned metal or epoxy object.

“Pitch” refers to a spacing between objects. Pitch can refer to the average spacing between a plurality of objects, the spacing between object centers and/or edges and/or the spacing between specific portions of objects, for example a tip, point and/or end of an object.

“Contact angle” refers to the angle at which a liquid-gas interface meets a solid.

“Flexible” refers to a property of an object which is deformable in a reversible manner such that the object or material does not undergo damage when deformed, such as damage characteristic of fracturing, breaking, or inelastically deforming. Flexible polymers are useful with the methods described herein. Specific flexible polymers include, but are not limited to: rubber (including natural rubber, styrene-butadiene, polybutadiene, neoprene, ethylene-propylene, butyl, nitrile, silicones), acrylic, nylon, polycarbonate, polyester, polyethylene, polypropylene, polystyrene, polyvinyl chloride, polyolefin, elastomers and other flexible polymers known to those of skill in the art. In certain embodiments, flexible objects or materials can undergo strain levels selected over the range of 1% to 1300%, 10% to 1300%, or 100% to 1300% without resulting in mechanical failure (e.g., breaking, fracturing or inelastically deforming). In some embodiments, flexible objects or materials can be deformed to a radius of curvature selected over the range of 100 μm to 3 m without resulting in without resulting in mechanical failure (e.g., breaking, fracturing or inelastically deforming).

“Fidelity” refers to the quality of a cast or molded object; fidelity can also refer to the ability of features to be replicated in a cast or molded object during a casting or molding process. “High fidelity” specifically refers to the situation where a majority of the features of the mold or primary object are replicated in the molding or casting process to the cast or molded objects, for example 50% to 100% of the features, 75% to 100% of the features, 90% to 100% of the features or 100% of the features.

“Replication” and “replicate” refer to the situation where features are transferred and/or recreated during casting and/or molding processes. Replicated features generally resemble the original features they are cast or molded from except that the replicated features represent the negative of the original features; that is where the original features are raised features, the replicated features are recessed features and where the original features are recessed features, the replicated features are raised features. In a specific embodiment, micropillars in a master object are replicated as microholes in a cast or molded object and microholes in the master object are replicated as micropillars in the cast or molded object.

“Macro mold” refers to an object mold for shaping or molding an object in a molding, casting or contact process. In some embodiments, a macro mold is used to simultaneously shape an object on a macro scale, for example where features are larger than 1 mm, such as 1 mm to 1 m, 1 cm to 1 m, or 5 cm to 1 m, and impart microfeatures to the surface of the object.

“Polymer” refers to a macromolecule composed of repeating structural units connected by covalent chemical bonds or the polymerization product of one or more monomers, often characterized by a high molecular weight. The term polymer includes homopolymers, or polymers consisting essentially of a single repeating monomer subunit. The term polymer also includes copolymers, or polymers consisting essentially of two or more monomer subunits, such as random, block, alternating, segmented, graft, tapered and other copolymers. Polymers useable in the present invention may be organic polymers or inorganic polymers and may be in amorphous, semi-amorphous, crystalline or partially crystalline states. Cross linked polymers having linked monomer chains are particularly useful for some applications of the present invention. Polymers useable in the methods, devices and device components of the present invention include, but are not limited to, plastics, elastomers, thermoplastic elastomers, elastoplastics, thermostats, thermoplastics and acrylates. Exemplary polymers include, but are not limited to, acetal polymers, biodegradable polymers, cellulosic polymers, fluoropolymers, nylons, polyacrylonitrile polymers, polyamide-imide polymers, polyimides, polyarylates, polybenzimidazole, polybutylene, polycarbonate, polyesters, polyetherimide, polyethylene, polyethylene copolymers and modified polyethylenes, polyketones, poly(methyl methacrylate, polymethylpentene, polyphenylene oxides and polyphenylene sulfides, polyphthalamide, polypropylene, polyurethanes, styrenic resins, sulfone based resins, vinyl-based resins, rubber (including natural rubber, styrene-butadiene, polybutadiene, neoprene, ethylene-propylene, butyl, nitrile, silicones), acrylic, nylon, polycarbonate, polyester, polyethylene, polypropylene, polystyrene, polyvinyl chloride, polyolefin or any combinations of these. Exemplary elastomers include, but are not limited to silicon containing polymers such as polysiloxanes including poly(dimethyl siloxane) (i.e. PDMS and h-PDMS), poly(methyl siloxane), partially alkylated poly(methyl siloxane), poly(alkyl methyl siloxane) and poly(phenyl methyl siloxane), silicon modified elastomers, thermoplastic elastomers, styrenic materials, olefenic materials, polyolefin, polyurethane thermoplastic elastomers, polyamides, synthetic rubbers, polyisobutylene, poly(styrene-butadiene-styrene), polyurethanes, polychloroprene and silicones. In an embodiment, a flexible polymer is a flexible elastomer.

“Young's modulus” and “elastic modulus” refer to a mechanical property of a material, device or layer equal to the ratio of stress to strain along an axis and under conditions which a material, device or layer remains within its elastic limit.

Methods are described herein for the production of microstructured objects. Specific methods are useful with one another, for example they can be performed in series for the manufacture of a sequence of microstructured objects. The microstructured objects made by the methods described herein include regions of microfeatures which can give a microstructured object a variety of useful properties. For example, the microfeatures can impart an increased hydrophobicity to an object and/or can give an object a self-cleaning ability. The microfeatures can also impart optical effects to an object, for example giving an object a prismatic effect, a specific color, or a directional dependent color change or color flop (e.g. the object appears a specific color when viewed from one angle and another color when viewed from another direction).

The microfeatures can also impart an increase of surface friction or grip to an object, and/or can give an object a specific tactile sensation such as feeling fuzzy, rough or squishy when touched. The microfeatures can also be located on a specific area or over the entire surface area of an object. For example, these embodiments can be useful for decreasing drag caused by turbulence of an object moving through a fluid (e.g., similar to the dimpling on a golf ball).

In a specific embodiment, the microfeatures can modify the heat transfer characteristics of an object, for example by changing the surface area of an object, changing how the surface interacts with fluids, or changing the behavior of nucleation sites. In a specific embodiment, the microfeatures can result in a decreased heat transfer by conduction, for example when the microfeatures have a high aspect ratio only the tops of the microfeatures will be in contact with another object for conductive heat transfer while the voids between surface features will not transfer heat well.

Microstructures can also be electrically conductive, for example metal microstructures or microstructures comprised of an electrically conductive polymer. These types of electrically conductive microstructures are useful, for example, as an array of electrical leads for electronic devices. The electrically conductive microstructures, for example, can be embossed directly onto the surface of an object.

The microstructured flexible molds described herein are useful for casting and molding methods. Specific embodiments of the methods described herein comprise a step of deforming at least a portion of a microstructured flexible mold such that at least a portion of a preselected pattern of microfeatures is located on a curved surface of the microstructured flexible mold. For example, at least a portion of the microstructured flexible mold is provided in a bent, flexed, compressed, stretched, expanded and/or strained configuration. In one embodiment, a deforming step is useful when separating and/or removing a cast object from the microstructured flexible mold.

In embodiments, the microstructured flexible mold comprises a polymer. Useful polymers include rubbers, silicone rubbers, polysiloxanes, PDMS, and any combination of these or other polymers known in the art. Optionally, the microstructured flexible mold comprises a composite. For example, the microstructured flexible mold can comprise a polymer and/or a material having a Young's modulus selected over the range of 300 kPa to 1000 GPa. In a specific embodiment, the microstructured flexible mold comprises carbon nanotubes.

In an embodiment, a method of fabricating a microstructured flexible mold comprises the steps of: providing a macro master mold; and providing a microstructured polymer having a preselected pattern of microfeatures to at least a portion of the surface of the macro master mold. In an embodiment, the microstructured polymer comprises a lithographically patterned flexible polymer. In an embodiment, the microstructured polymer comprises a flexible polymer cast or molded from a lithographically patterned substrate.

In a specific embodiment, a method of fabricating a microstructured flexible mold comprises the steps of: providing a semiconductor wafer; patterning the semiconductor wafer with a preselected pattern of microfeatures; molding an uncured flexible polymer to the patterned semiconductor wafer; curing the polymer, thereby forming a microstructured flexible polymer having the preselected pattern of microfeatures; and removing the microstructured flexible polymer from the patterned semiconductor wafer, thereby forming the microstructured flexible mold. In one embodiment, the patterning step comprises patterning the semiconductor wafer using an anisotropic etching method.

In embodiments where a semiconductor wafer is patterned, methods known to those of skill in the art may be utilized. For certain embodiments, a semiconductor wafer includes an overlayer, for example a layer of photoresist. As used herein, a patterned semiconductor wafer refers to a semiconductor wafer having a pattern imparted directly into the semiconductor material, a semiconductor wafer having unpatterned semiconductor material and a patterned overlayer, and/or a semiconductor wafer having patterned semiconductor material and a patterned overlayer. Specific patterning methods include, but are not limited to photolithography, photoablation, laser ablation, laser patterning, laser machining, x-ray lithography, e-beam lithography and nano-imprint lithography. Semiconductor wafer patterning methods also include etching methods and methods useful for patterning overlayers, for example photoresist layers.

For some embodiments, the microstructured flexible molds described herein are useful for casting multiple objects. For example, after casting a first object, a microstructured flexible mold is reusable for casting an additional object. A method of this aspect further comprises the steps of applying a second liquid metal having a melting point selected within the range of 35 to 650° C. to the microstructured flexible mold; cooling the liquid metal, thereby replicating at least a portion of the preselected pattern of microfeatures in a second solid metal; and removing the microstructured flexible mold from the second solid metal, thereby making an additional microstructured metal object.

Another method of this aspect further comprises the steps of applying a second epoxy precursor or liquid thermoset polymer to the microstructured flexible mold; curing the epoxy precursor or liquid thermoset polymer, thereby replicating at least a portion of the preselected pattern of microfeatures in a second solid epoxy; and removing the microstructured flexible mold from the second solid epoxy, thereby making an additional microstructured epoxy object.

Optionally, the methods described herein further comprise a step of treating at least a portion of the microfeatures of the microstructured flexible mold, for example before a casting, molding or embossing step. In an exemplary embodiment, the step of treating comprises applying a chemical treatment to at least a portion of the microfeatures of the microstructured flexible mold, for example selected from the group consisting of: napfin, paraffin wax, a polysiloxane, a synthetic wax, mineral oil, Teflon, a fluoropolymer, a silane, a fluorosilane, a thiol, a surfactant and any combination of these. In an exemplary embodiment, the step of treating comprises exposing at least a portion of the microfeatures of the microstructured flexible mold to a physical treatment, for example selected from the group consisting of: an oxygen plasma, UV radiation and both an oxygen plasma and UV radiation. Without wishing to be bound by any theory, it is believed that treating the microstructured flexible mold increases interaction between a cast liquid and the microstructured flexible mold. Such treatment can also reduce the interfacial tension between the cast liquid and the microstructured flexible mold, allowing, for example, for more intimate contact between the cast liquid and the microstructured flexible mold.

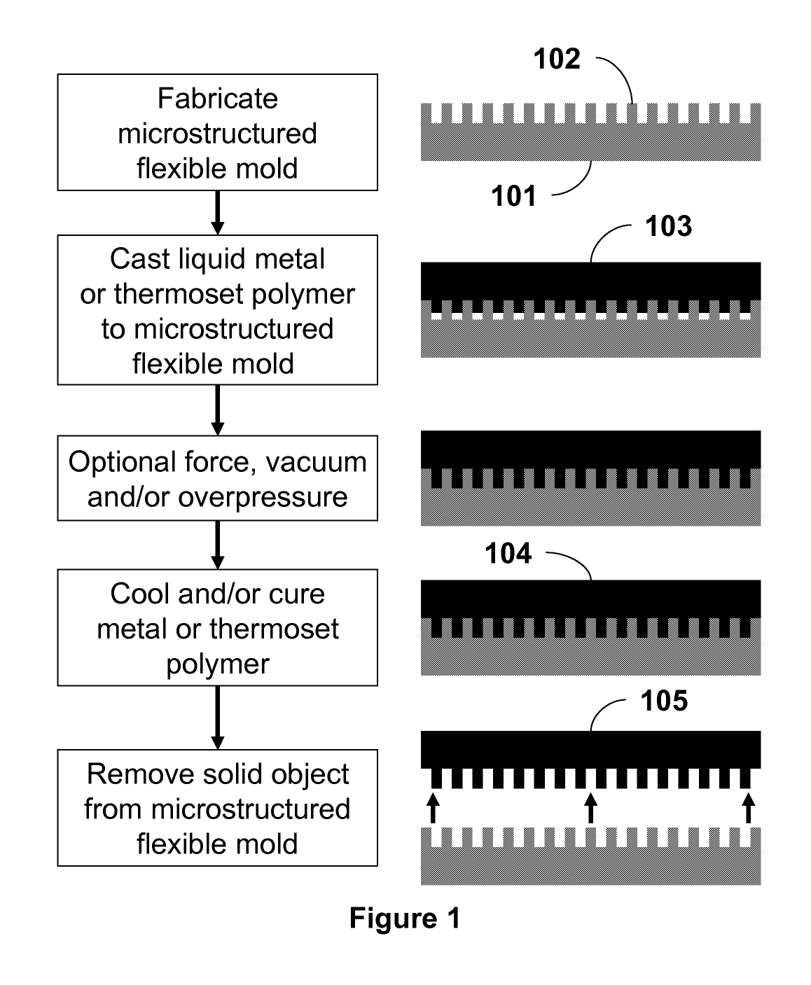

FIG. 1 illustrates an exemplary method for making a microstructured cast object. A microstructured flexible mold 101 is fabricated, having a preselected pattern of microfeatures 102 on at least a portion of the surface thereof. A liquid metal or thermoset polymer 103 is cast to the microstructured flexible mold 101. Optionally, a force is applied between the liquid metal or thermoset polymer 103 and the microstructured flexible mold 101 and/or the liquid metal or thermoset polymer 103 and the microstructured flexible mold 101 are placed under vacuum or a pressure above ambient pressure. For certain embodiments, application of a force, a vacuum and/or overpressure conditions provides more intimate contact between the liquid metal or thermoset polymer 103 and the microstructured flexible mold 101. After the liquid metal or thermoset polymer 103 cools and/or cures to form solid metal or epoxy 104, the microstructured flexible mold 101 is removed from the solid metal or epoxy, thereby making a microstructured cast metal or epoxy object 105.

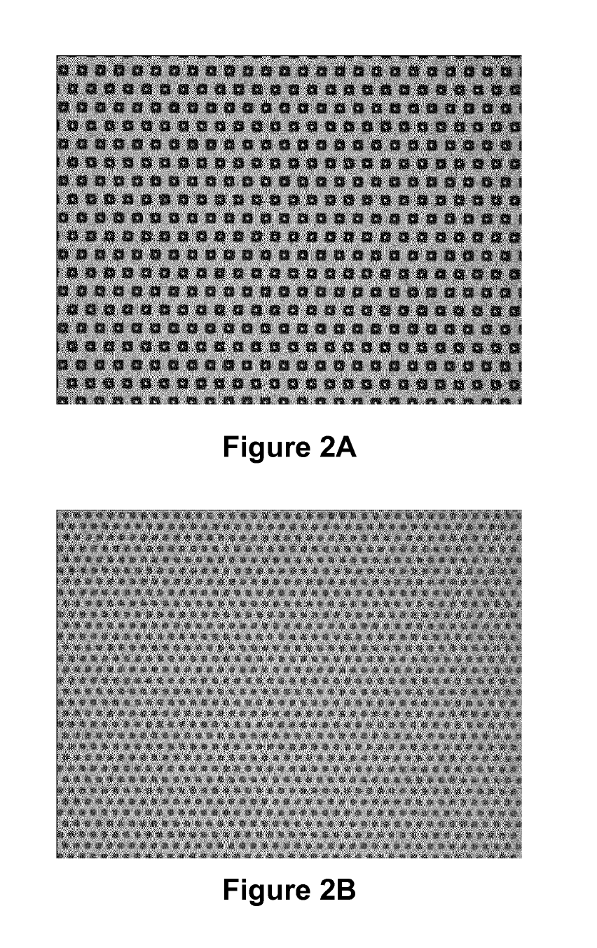

FIGS. 2A and 2B depict images of microstructured epoxies. The microstructured epoxy in FIG. 2A was cast to include 50 μm square holes 201 with a depth of 50 μm. The microstructured epoxy in FIG. 2B was cast to include 15 μm square holes 202 with a depth of 50 μm. The epoxies were formed of a two-part mixed thermoset polymer.

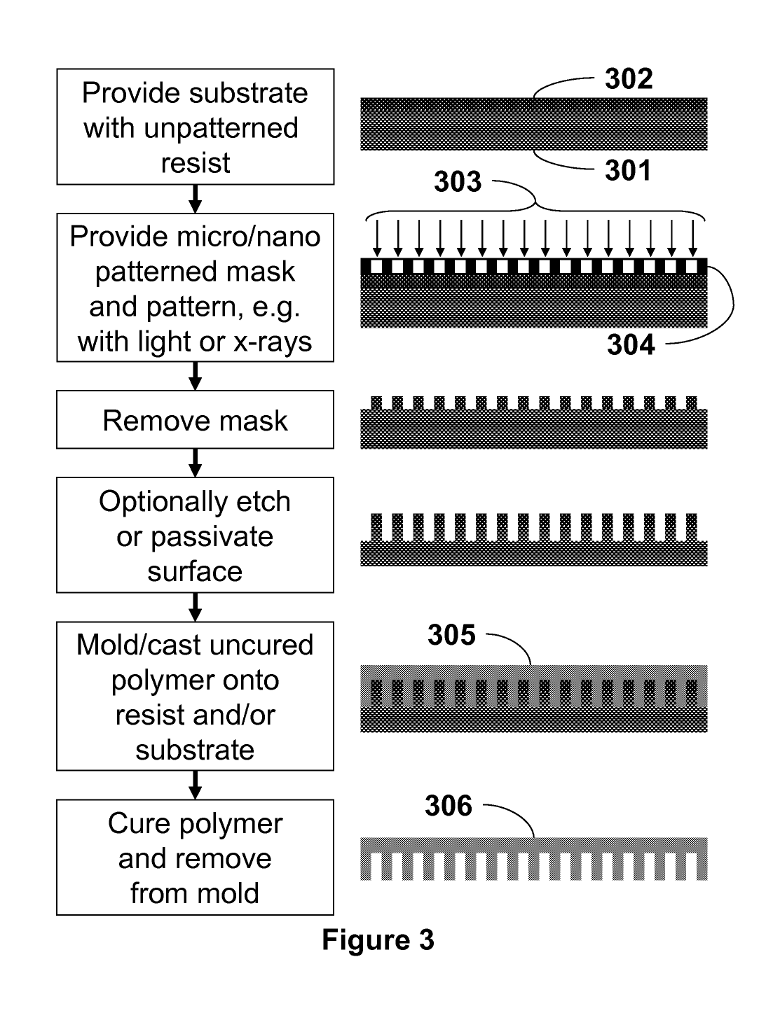

FIG. 3 illustrates an exemplary method for fabricating a microstructured flexible mold. The method begins with by patterning a substrate 301. For example, the substrate is topped with a photosensitive polymer or resist 302 sensitive to light or particles. By shining light 303 through a stencil mask 304 onto the resist 302, micrometer-scale or nanometer-scale structures can be formed in the resist 302. In a specific embodiment, the substrate is a semiconductor wafer. Other techniques and/or kinds of electromagnetic waves, energy beams, or particles can also be used to form the microfeatures or nanofeatures. The microfeatures formed thereby can optionally form patterns, preferably a preselected pattern. A key characteristic is that the manufacturing process controls the size, shape, and position of the microfeatures with micrometer-scale or nanometer-scale accuracy and precision. After removing the mask, the substrate is optionally etched or has its surface passivated. Uncured flexible polymer 305 is then molded or cast to the microfeatures and cured by heat, time, UV light or other curing methods. When the cured microstructured polymer 206 is removed from the patterned substrate-resist, the microfeatures from the substrate-resist are replicated and mechanically flexible. The microstructured flexible polymer 306 is then usable as a mold for additional casting methods.

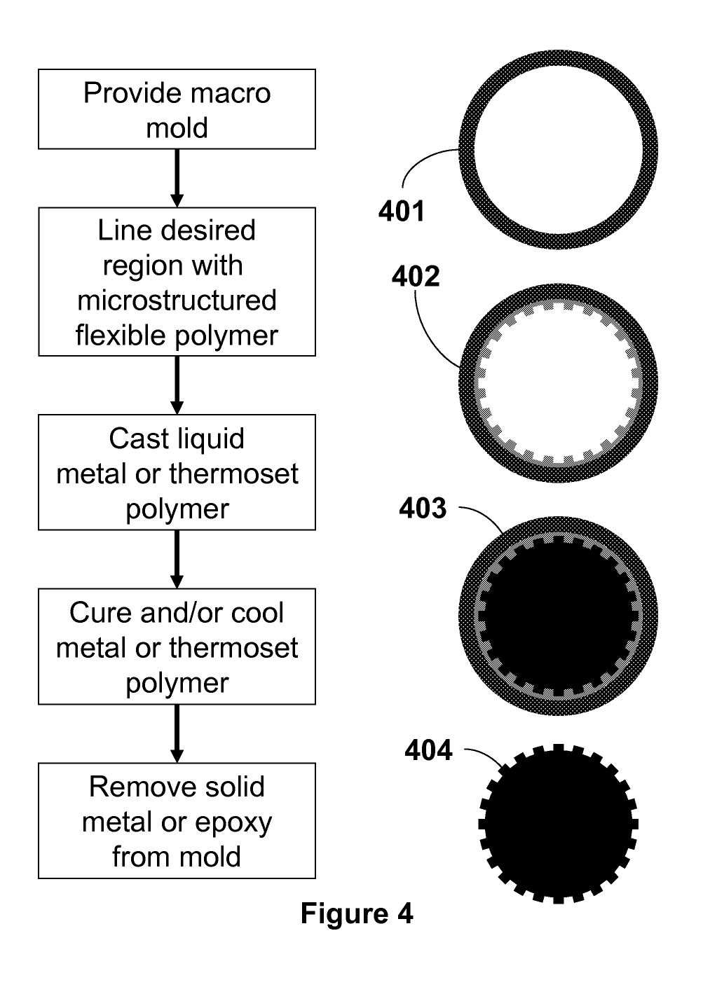

FIG. 4 illustrates further optional steps for fabricating a microstructured flexible mold. A macro mold 401 of a desired shape is first provided. The region on which casting is to take place is then lined with a microstructured flexible polymer 402. FIG. 4 further illustrates casting of a liquid metal or thermoset polymer 403 into the mold comprising macro mold 401 and microstructured flexible polymer 402. After the liquid metal or thermoset polymer is allowed to cool and/or cure, the mold and microstructured solid metal or epoxy 404 are separated.

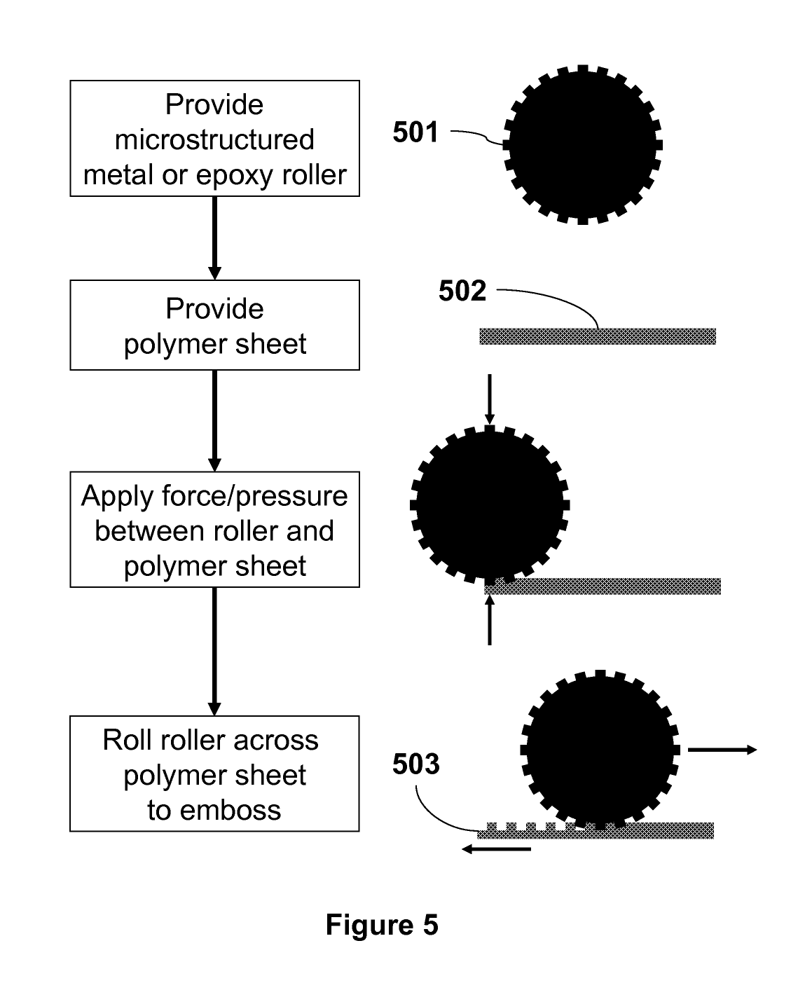

FIG. 5 illustrates an exemplary method for embossing a polymer sheet using a microstructured roller. First, a microstructured metal or epoxy roller 501 is provided. A polymer sheet 502 is also provided and brought into contact with microstructured metal or epoxy roller 501. Optionally, the temperature of polymer sheet 502 is elevated. A force and/or pressure is applied between the microstructured roller 501 and the polymer sheet 502 as the microstructured roller 501 is rolled over polymer sheet 502. As the microstructured roller 501 is rolled over polymer sheet 502, microstructures are embossed into the polymer sheet, forming a microstructured polymer sheet 503.

The invention may be further understood by the following non-limiting examples.

### Example 1

This example describes casting-based microfabrication of metal microstructures and nanostructures. The metal was cast into flexible silicone molds which were themselves cast from microfabricated silicon templates. Microcasting was demonstrated in two metal alloys of melting temperature 70° C. or 138° C. Many structures were successfully cast into the metal with excellent replication fidelity, including ridges with periodicity 400 nm and holes or pillars with diameter in the range 10-100 μm and aspect ratio up to 2:1. The flexibility of the silicone mold permits casting of curved surfaces, which were demonstrated by fabricating a cylindrical metal roller of diameter 8 mm covered with microstructures. The metal microstructures are in turn used as a reusable molding tool.

Metals have attractive properties for microelectromechanical systems (MEMS) because of their high thermal and electrical conductivity, optical properties, high mechanical toughness, and ductility. Some metals such as Titanium are biocompatible and can also operate at very high temperature. Metal microstructures and nanostructures are attractive for manufacturing molds for Nanoimprint Lithography (NIL), as they can be reused many times more than silicon or quartz. Published articles report fabrication of metal sub millimeter, micro-, and nanostructures using forging, electroplating, and casting.

Forging can produce small scale structures in ductile metals. In one demonstration of metal forging, 40 nm wide grooves were embossed into free standing aluminum thin film at elevated temperatures by silicon carbide (SiC) mold templates. Similarly, 300 nm grooves were fabricated into aluminum films on silicon. Another study reported sub-10 nm grooves embossed into a thick nickel film using a diamond mold template. Silicon can be used as a mold for metal forging, although silicon does not have the compressive strength of SiC or diamond, and so silicon mold templates require lower forging pressures and more ductile metals. For example, silicon molds forged 250 nm wide and 1 μm tall structures into flat gold and silver, where the silicon was sacrificed in a lost mold process. Surface oxidation was also a challenge in working with these metals. It is not necessary to sacrifice the silicon under all circumstances: it was possible to de-mold a silicon mold template following forging of 50 μm structures into a thin film of aluminum on a silicon substrate. Molecular dynamics (MD) simulations of small-scale metal forging found that the pile-up of excess material cannot be avoided and that forging pressure increases for decreased metal film thickness.

Microscale metal electroplating avoids pile-up of excess material and is less expensive than forging, but is slower and sample size can be limited. Several recent reports have shown that flexible nickel sheets can be electroplated onto polymer structured by NIL after sputtering a seed layer onto the structured polymer. After dissolving the polymer in a lost mold process, the flexible nickel can be wrapped around a roller that can emboss continuous sheets of polymer with 1 μm wide holes 250 nm deep. Electroplated Ni—Co has also been used to hot emboss Mg—Cu—Y bulk metallic glass (BMG) that then embossed polymethylmethacrylate (PMMA) micro lenses.

Somewhat less work has been reported on the manufacture of metal microstructures by casting. One strategy for sub-millimeter casting of either aluminum-bronze or gold alloy is to cast into small plaster molds that were themselves cast from injection molded PMMA gears. One strategy for microscale metal casting of one dimensional structures is to cast microstructures into wax, cast ceramic into the wax, cure the ceramic in a lost wax method, and finally cast metal into the microstructured ceramic.

These recent techniques that can produce metal microstructures are mostly limited to metal that is flat in a thin film. There is a need for inexpensive, parallel processes for producing metal microstructures on curved surfaces. This example describes using an inexpensive, reusable, flexible mold with three dimensional microstructures to meet that need.

The metals for microcasting were selected to have a eutectic melting temperature below the maximum working temperature range of the microstructured silicone molds, which was about 350° C. The metals were commercially available alloys CerroTru and CerroBend. CerroTru was composed of 58% Bismuth and 42% Tin, had a melting point of 138° C., a compressive strength of 62 MPa sustainable for 5 minutes, an electrical conductivity of 5% compared to pure Copper, and a Brinell Hardness of 22. CerroBend was composed of 50% Bismuth, 26.7% Lead, 11.3% Tin, and 8.5% Cadmium. CerroBend melted at 70° C., had a compressive strength of 28 MPa sustainable for 5 minutes, an electrical conductivity of 4.17% compared to pure Copper, and a Brinell Hardness of 9.2.

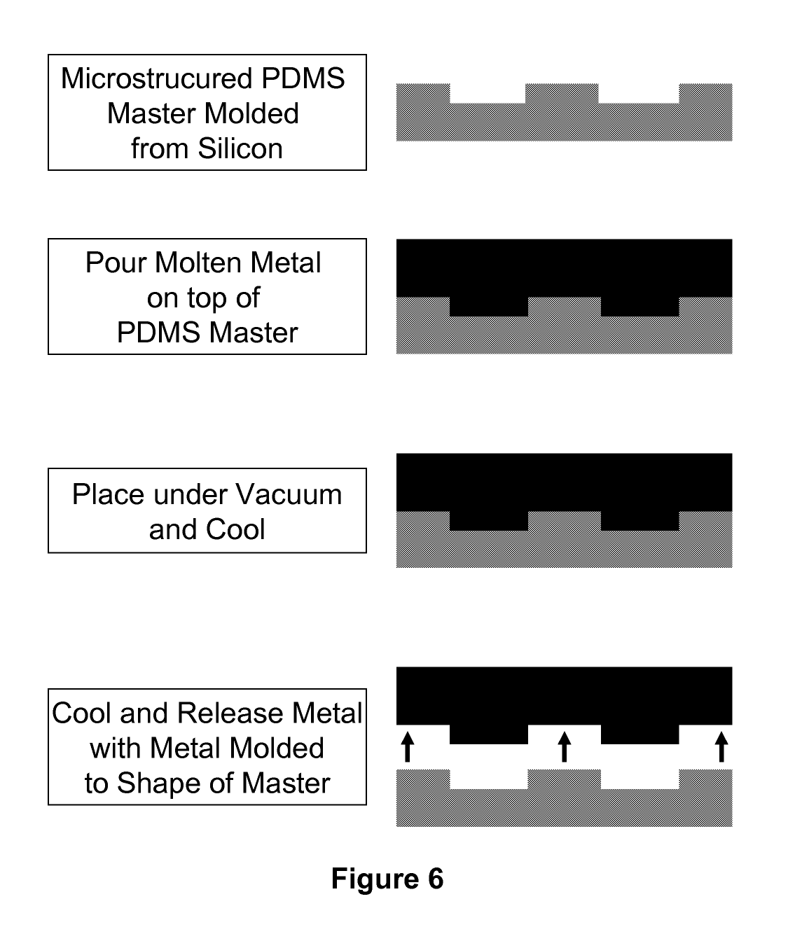

FIG. 6 shows the casting process. The process begins with a flexible microstructured silicone master, Sylgard 184 by Dow Corning. The silicone master itself was vacuum cast from a silicon master etched with the Bosch process. A vacuum oven heated the silicone master to 20° C. above the melting point of the metal. Molten metal was poured onto the silicone master. The vacuum oven degassed the molten metal for 5 minutes while maintaining a temperature 20° C. above melting point to keep the metal hot enough to remain liquid while air bubbles degassed. After the degassing step, the vacuum oven was vented to atmospheric pressure to decrease the size of any remaining gas bubbles within the metal. The metal solidified upon cooling and the silicone master was easily released.

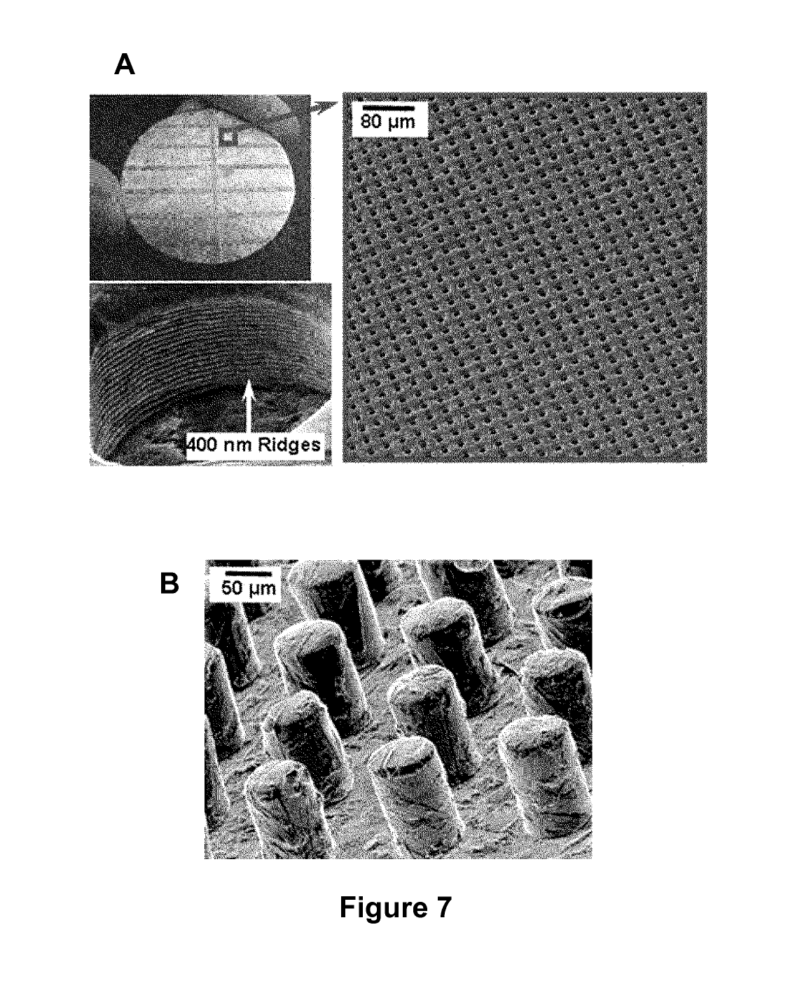

FIG. 7 highlights results from the metal casting process. FIG. 7 A) shows an array of 10 μm diameter holes in metal that are 15 μm deep. FIG. 7 A) also shows the 400 nm ridges inside a hole. The 400 nm ridges came from the Bosch process that etched the original silicon master that cast the PDMS master. FIG. 7 B) shows cast metal pillars that are 50 μm in diameter and 100 μm tall.

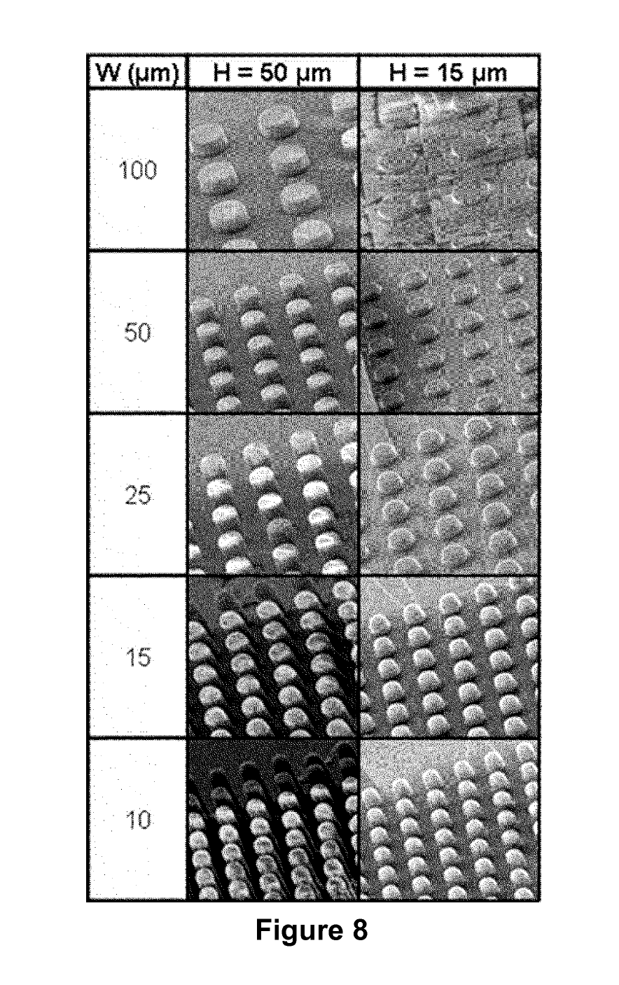

A systematic study showed that high fidelity metal microstructures can be replicated from master microstructures of size between 400 nm and 100 mm, and with height:width aspect ratio of up to 2:1. FIG. 8 shows the set of master silicone micropillars used, which were of diameter 100, 50, 25, 15, and 10 μm. On the right hand side of FIG. 8 the master pillars were all 15 μm tall. On the left hand side of FIG. 8 the master pillars were all 50 μm tall. This set of master microstructures has sizes ranging from 10 to 100 μm and aspect ratios ranging from 1:7 to 5:1.

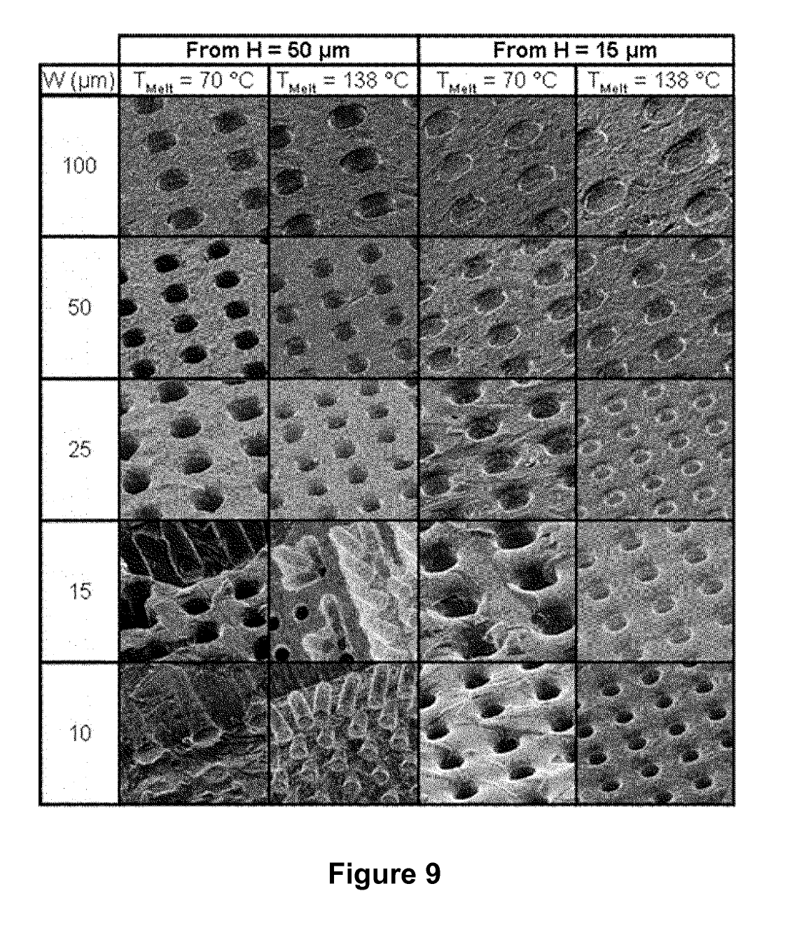

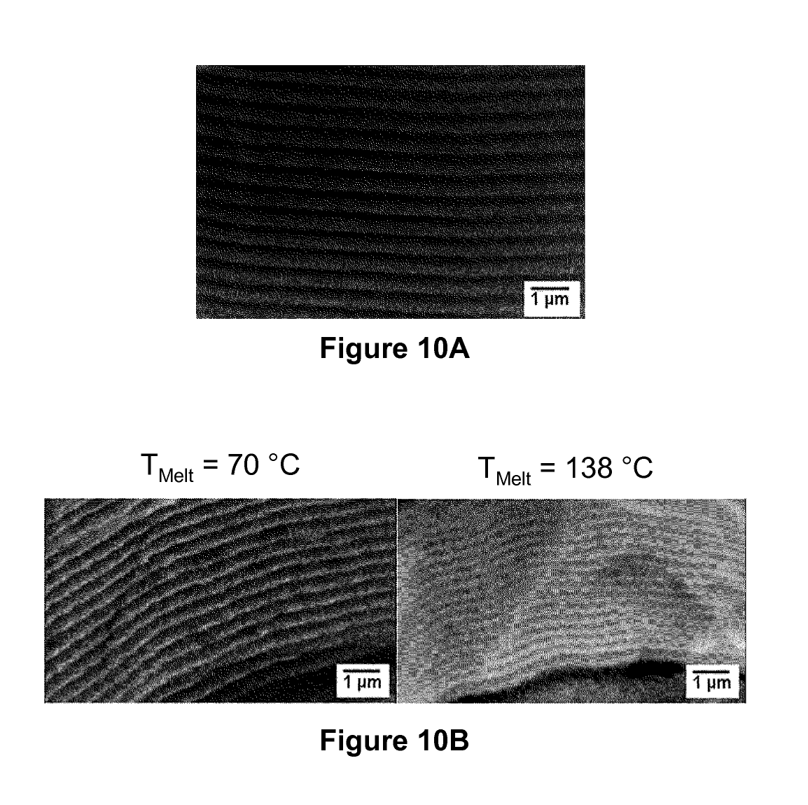

FIG. 9 shows metal microstructures cast from the silicone master. All 15 μm tall master microstructures cast into both the 70° C. and 138° C. melting point metals, forming 15 μm deep holes that range in aspect ratio from 1:7 to 3:2. Of the 50 μm tall master microstructures, the 100, 50, and 25 μm diameter master microstructures replicated well. The 15 μm diameter×50 μm tall master microstructures partially replicated. Holes next to metal cast to the shape of buckled master pillars are evidence of the partial replication. The 10 μm diameter×50 μm tall master pillars did not replicate well—metal cast to the shape of buckled master pillars are evidence of poor replication. For the 50 μm tall master microstructures, aspect ratios ranging from 1:2 to 2:1 replicated well. FIG. 10A shows the 400 nm wide lines on the side of the master silicone pillars, and FIG. 10B shows the 400 nm wide structures that replicated into both the 70° C. and 138° C. melting point metals. The two metals used in this study cast microstructures equally well.

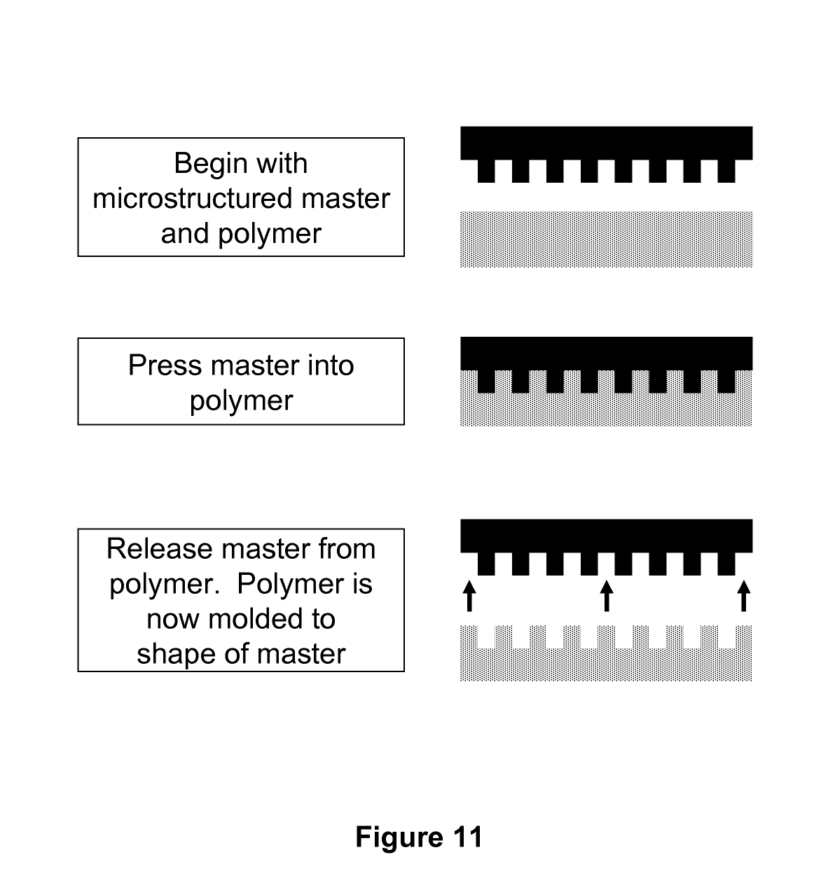

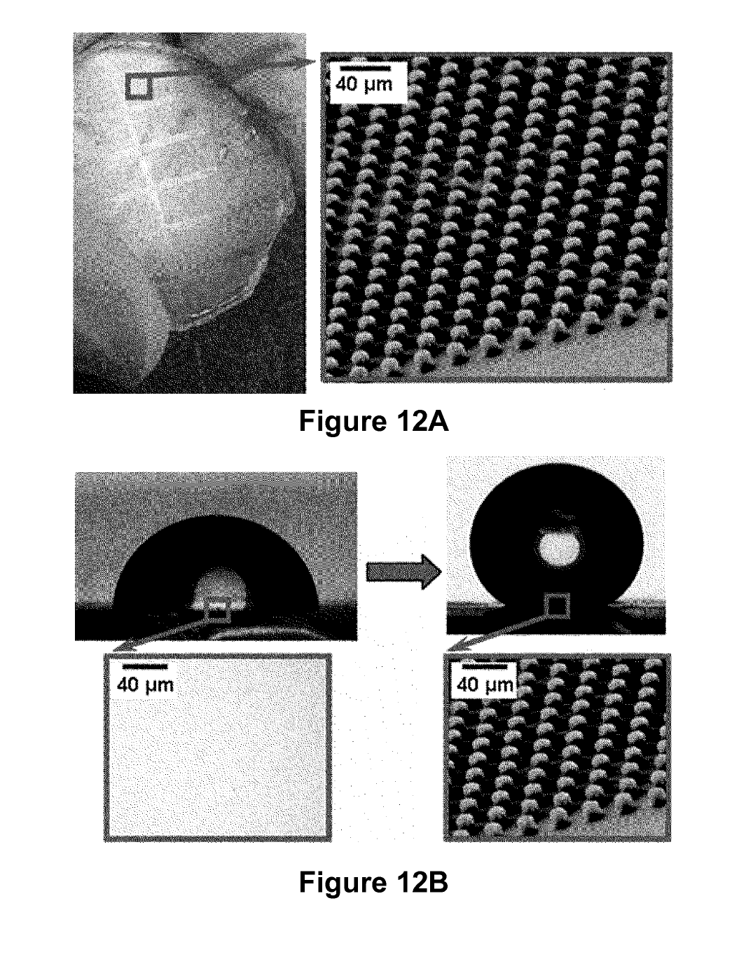

One application of metal microstructures is for use as an embossing tool, and so the metal microstructures were used to emboss a polymer. FIG. 11 shows the embossing process, in which a metal master is pressed into a polymer. When the polymer is a thermoplastic, heat is applied to soften the polymer, allowing the master to emboss the polymer with less force. Here, a hot plate heated a thermoset polymer precursor to partially cure the precursor instead of softening it. Sylgard 184 base and accelerant were mixed in a 10:1 ratio by weight, and the mixture degassed under vacuum for 5 minutes. A hot plate at 180° C. heated the silicone for 2 minutes to partially cure the silicone. Then 138° C. melting point metal that was cast into a microstructured embossing die embossed the partially cured silicone. The silicone fully cured for 1 minute at embossing pressure of 200 kPa. When the microcast metal released the silicone, the holes from the microcast metal had embossed pillars into the silicone as shown in FIG. 12.

The molding fidelity was of sufficient quality and homogeneity to produce a macroscopic effect. The embossed micropillars enhanced the hydrophobicity of the silicone by mimicking the structure of the lotus plant, shown in FIG. 12B. FIG. 12B shows a 5 μl water droplet on flat silicone. The angle the water droplet makes with the solid is denoted as the contact angle and is 92°. FIG. 12B shows that the contact angle increased to 152° after embossing the silicone with the microcast metal. The contact angle is a static measure of hydrophobicity, and the slide angle is a dynamic measure. The slide angle is measured by placing a droplet on a surface and then tilting that surface until the droplet slides. 10 μl water droplets cling to flat silicone even when it tilts to 90°, but the pillars shown in FIG. 12B reduce the slide angle to 48°.

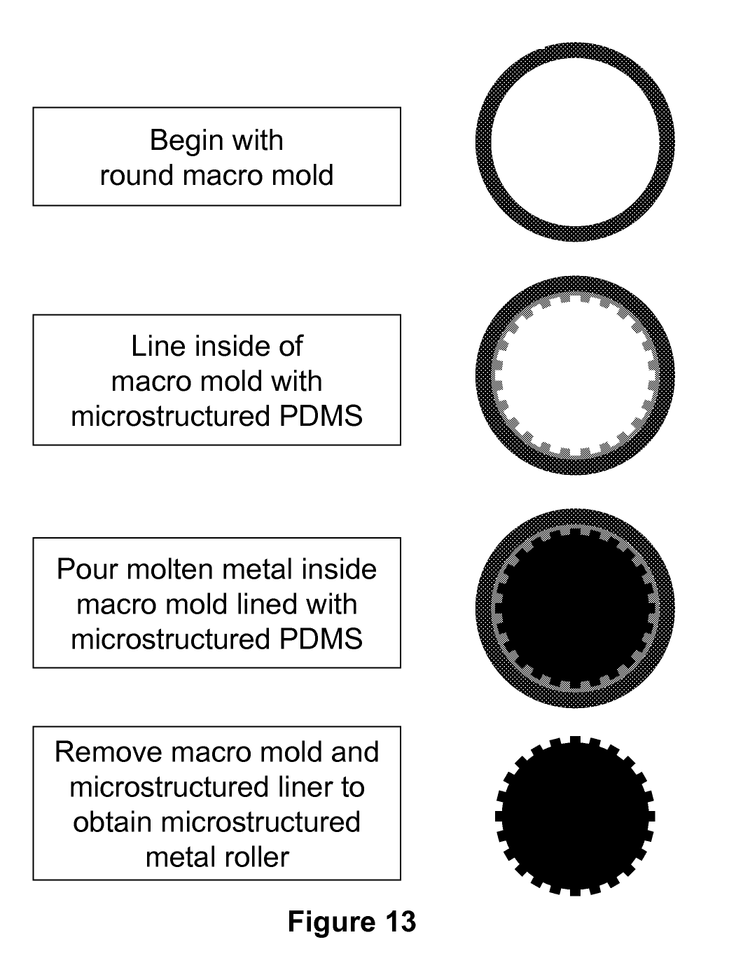

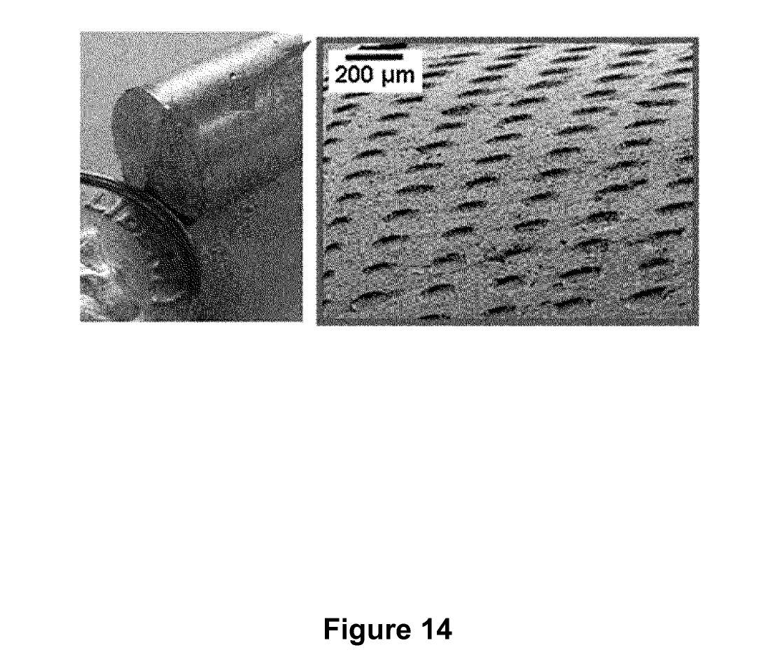

Because the silicone mold is flexible, it is possible to mold microstructures onto curved surfaces. Metal microstructures were cast into a macro cylindrical roller useful as an embossing roller. FIG. 13 shows the process of microcasting a metal roller. The process begins with a round macro master. Microstructured polymer such as silicone lines the inside of the macro master. Molten metal casts to the inside of the curved microstructured round master, and when the macro master and microstructured liner release the metal, a microstructured metal roller results. FIG. 14 shows the resulting microstructured metal roller that could be used in industrial roll-to-roll processes. The roller is 8 mm in diameter, and the curvature of the roller is limited by the height and spacing of the structures on the flexible master. If the structures are sufficiently tall and in sufficient proximity that they touch when they are flexed to the curvature of the macro mold, then the resulting metal roller will have distorted structures, and demolding may also be difficult.

Previous techniques to produce metal microstructures have been mostly limited to flat surfaces and thin films. Inexpensive, parallel processes that lack caustic chemicals do not currently exist for producing curved, bulk metal with three dimensional metal microstructures. Much of the forging work to date has used SiC or diamond molds patterned by electron beam lithography to forge thin metal films deposited on silicon. A metal film bonded to a second material has the general disadvantage of being constrained by the properties of the second material. In this specific case, one constraint is flatness of the forged metal. Molds made of SiC and diamond are expensive because of material and processing techniques.

While using silicon molds can reduce the mold material and fabrication expense, silicon die wear and failure problems exist because of the brittle nature of silicon. Designing the molds with sloped sidewalls lacking sharp edges and corners can mitigate mold wear and failure. Using maximum aspect ratios of 1:1 in mold structures also reduces mold wear and failure. One previous report used finite element analysis (FEA) to investigate microscale room temperature imprinting of aluminum with silicon, and it suggests silicon mold wear occurs because of misalignment during molding and demolding, causing uneven tensile stresses and frictional tractions. Ductile metals such as platinum, gold, and silver are often used in forging processes to mitigate die wear and failure. While precious metals are ductile, they are also much more expensive than the alloys used in the present study. Casting can be used to microstructure metals, but previous work has used lost mold techniques and brittle plaster molds to fabricate three dimensional submillimeter structures and one-dimensional microscale structures. Compliant polymer molds have an advantage over silicon in terms of wear, over lost molding techniques because polymer molds are reusable and also lack the wax and ceramic casting steps which introduce defects, and over brittle plaster in terms of demolding ease. Also, replacing a worn polymer mold is inexpensive.

Replication fidelity depended upon relative temperatures between the molten metal and the silicone and also the thickness of the silicone master, apparently due to the thermomechanical deformation of silicone. In the first trials, molten metal 30° C. above the silicone temperature was poured onto 0.7 mm thick silicone masters. The silicone microstructures replicated into the metal, but the silicone contracted and deformed the metal macrostructure. Decreasing the temperature of the molten metal to equal the temperature of the preheated silicone and increasing the thickness of the silicone masters to 2 mm enabled the silicone masters to withstand the thermal stresses of casting and produced the results presented here. Thin silicone also works well if adhered to a stiff surface. Another challenge to casting the metal with high fidelity was the high surface tension of the molten metal. Surface tension caused the liquid metal to be suspended on the tops of the silicone pillars rather than be in intimate contact with the spaces between the silicone pillars. Applying mild pressure to the liquid metal caused the suspended liquid to collapse into the spaces between the silicone pillars.

The present example describes casting of low melting temperature metal alloys directly to microstructured silicone. A systematic study showed that metal reliably cast to ridges with periodicity 400 nm and holes or pillars with diameter in the range 10-100 μm and aspect ratio up to 2:1. The casting techniques required no solvents, and the mold used in this process is highly flexible in 2 dimensions, enabling fabrication of metal microstructures into surface curvature in 2 dimensions. Using silicone molds allows a route to metal microcasting that does not require microfabrication equipment. This example demonstrates the usefulness of microstructured low melting temperature alloys by casting an embossing die that then embosses micropillars into polymer, enhancing the hydrophobicity of the polymer. Another demonstration casts a microstructured cylindrical metal roller that is useful for embossing sheets of polymer in roll-to-roll processes. Useful roll-to-roll process also include those where a polymer roller micromolds a continuous sheet of metal. In another embodiment, molten metal enters a cold polymer roller, and the roller presses the metal into its microstructures, outputting solidified microstructured metal in a continuous sheet. Similarly, a microstructured polymer conveyor is useful as a mold for a continuous stream of molten metal that cools once the molten metal is cast to the polymer microstructures and is removed as a continuous sheet.

Figure Captions:

FIG. 6. Process for Microcasting Metal. A) Begin with a microstructured silicone master that was cast from silicon. B) Pour Molten Metal on top of silicone master. C) Place molten metal and silicone under vacuum to release entrapped gas. Then vent to atmosphere to reduce size of any remaining gas bubbles. D) Cool and release metal with metal cast to shape of silicone master.

FIG. 7. Microcast Metal. A) Metal with 10 μm diameter holes 15 μm deep. 400 nm ridges from the Bosch process are viewable in the picture showing a single 25 μm diameter hole. B) Metal Pillars 50 μm Diameter and 100 μm Tall.

FIG. 8. Set of microstructures in the silicone master. Matrix showing master pillars with height 50 and 15 μm and structure widths of 100, 50, 25, 15, and 10 μm.

FIG. 9. Set of metallic microstructures cast. Matrix showing quality of casting from master pillars with height 50 and 15 um; 2 metal alloys with melting points 70° C. and 138° C.; and structure widths of 100, 50, 25, 15, and 10 μm.

FIG. 10. 400 nm wide structures in sidewall of A) Silicone master pillars and B) Metal holes cast from silicone master.

FIG. 11. Process of Embossing Polymer. A) The embossing process begins with a microstructured master and polymer. B) The master presses into the polymer. C) The master releases the polymer with the polymer molded to the shape of the master.

FIG. 12. Microcast Metal used as embossing master. A) silicone embossed by Microcast Metal. B) Left: 5 μl water droplet on flat silicone with contact angle 92°. Right: 5 μl water droplet on silicone embossed with microstructured metal alloy with contact angle 152°. The silicone pillars have a diameter of 10 μm, a pitch of 20 μm, and a height of 15 μm.

FIG. 13. Process of microcasting a Metal Roller. A) The process begins with a round macro master. B) Microstructured polymer such as silicone lines the inside of the macro master. C) Molten metal casts to the inside of the curved microstructured round master. D) When the macro master and microstructured liner release the metal, a microstructured metal roller results.

FIG. 14. Microcast Metal Roller showing 100 μm diameter holes 15 μm deep. The roller can be used to emboss sheets of polymer in roll-to-roll processes.

### REFERENCES

Pornsin-sirirak T N, Tai Y C, Nassef H, and Ho C M 2001 Titanium-alloy MEMS wing technology for a micro aerial vehicle application. Sensors and Actuators A-Physical. 89(1-2): p. 95-103.
Van Kessel P F, Hornbeck L J, Meier R E, and Douglass M R 1998 MEMS-based projection display. Proceedings of the Ieee. 86(8): p. 1687-1704.
Parker E R, Rao M P, Turner K L, Meinhart C D, and MacDonald N C 2007 Bulk micromachined titanium microneedles. Journal of Microelectromechanical Systems. 16(2): p. 289-295.
Makela T, Haatainen T, Majander P, Ahopelto J, and Lambertini V 2008 Continuous double-sided roll-to-roll imprinting of polymer film. Japanese Journal of Applied Physics. 47(6): p. 5142-5144.
Bohm J, Schubert A, Otto T, and Burkhardt T 2001 Micro-metalforming with silicon dies. Microsystem Technologies. 7(4): p. 191-195.
Buzzi S, Robin F, Callegari V, and Loffler J F 2008 Metal direct nanoimprinting for photonics. Microelectronic Engineering. 85(2): p. 419-424.
Chen Y F, Zhou Y, Pan G H, Huq E, Lu B R, Xie S Q, Wan J, Shu Z, Qu X P, Liu R, Banu S, Birtwell S, and Jiang L D 2008 Nanofabrication of SiC templates for direct hot embossing for metallic photonic structures and meta materials. Microelectronic Engineering. 85(5-6): p. 1147-1151.
Cheng M C, Hsiung H Y, Lu Y T, and Sung C K 2007 The effect of metal-film thickness on pattern formation by using direct imprint. Japanese Journal of Applied Physics Part 1-Regular Papers Brief Communications & Review Papers. 46(9B): p. 6382-6386.
Hsieh C W, Hsiung H Y, Lu Y T, Sung C K, and Wang W H 2007 Fabrication of subwavelength metallic structures by using a metal direct imprinting process. Journal of Physics D-Applied Physics. 40(11): p. 3440-3447.
Jiang J, Mei F H, Meng W J, Sinclair G B, and Park S 2008 Direct microscale imprinting of Al at room temperature with Si inserts. Microsystem Technologies-Micro-and Nanosystems-Information Storage and Processing Systems. 14(6): p. 815-819.
Lister K A, Thoms S, Macintyre D S, Wilkinson C D W, Weaver J M R, and Casey B G 2004 Direct imprint of sub-10 nm features into metal using diamond and SiC stamps. Journal of Vacuum Science & Technology B. 22(6): p. 3257-3259.
Pang S W, Tamamura T, Nakao M, Ozawa A, and Masuda H 1998 Direct nano-printing on Al substrate using a SiC mold. Journal of Vacuum Science & Technology B. 16(3): p. 1145-1149.
Makela T, Haatainen T, Majander P, and Ahopelto J 2007 Continuous roll to roll nanoimprinting of inherently conducting polyaniline. Microelectronic Engineering. 84(5-8): p. 877-879.
Makela T, Jussila S, Kosonen H, Backlund T G, Sandberg H G O, and Stubb H 2005 Utilizing roll-to-roll techniques for manufacturing source-drain electrodes for all-polymer transistors. Synthetic Metals. 153(1-3): p. 285-288.
Makela T, Jussila S, Vilkman M, Kosonen H, and Korhonen R 2003 Roll-to-roll method for producing polyaniline patterns on paper. Synthetic Metals. 135(1-3): p. 41-42.
Haatainen T, Majander P, Riekkinen T, and Ahopelto J 2006 Nickel stamp fabrication using step and stamp imprint lithography. Microelectronic Engineering. 83(4-9 SPEC ISS): p. 948-950.
Baumeister G, Okolo B, and Rogner J 2008 Microcasting of Al bronze: influence of casting parameters on the microstructure and the mechanical properties. Microsystem Technologies-Micro-and Nanosystems-Information Storage and Processing Systems. 14(9-11): p. 1647-1655.
Baumeister G, Rath S, and Hausselt J 2006 Microcasting of Al bronze and a gold base alloy improved by plaster-bonded investment. Microsystem Technologies-Micro-and Nanosystems-Information Storage and Processing Systems. 12(8): p. 773-777.
Chen H L, Chuang S Y, Cheng H C, Lin C H, and Chu T C 2006 Directly patterning metal films by nanoimprint lithography with low-temperature and low-pressure. Microelectronic Engineering. 83(4-9): p. 893-896.
Cheng M C, Sung C K, and Wang W H 2007 The effects of thin-film thickness on the formaton of metallic patterns by direct nanoimprint. Journal of Materials Processing Technology. 191(1-3): p. 326-330.
Makela T, Lambertini V, Haatainen T, Majander P, and Ahopelto J. Continuous 2-sided roll to roll nanopatterning of a polymer film. 2007. Kyoto, Japan: Institute of Electrical and Electronics Engineers Computer Society, Piscataway, N.J. 08855-1331, United States.
Pan C T, Wu T T, Chang Y C, and Huang J C 2008 Experiment and simulation of hot embossing of a bulk metallic glass with low pressure and temperature. Journal of Micromechanics and Microengineering. 18(2).
Pan C T, Wu T T, Chen M F, Chang Y C, Lee C J, and Huang J C 2008 Hot embossing of micro-lens array on bulk metallic glass. Sensors and Actuators a-Physical. 141(2): p. 422-431.
Schmitz G J, Grohn M, and Buhrig-Polaczek A 2007 Fabrication of micropatterned surfaces by improved investment casting. Advanced Engineering Materials. 9(4): p. 265-270.
Bolton Metal Products, Cerro Alloy Material Property Data Sheet. 2008: Bellefonte, Pa.
Cannon A H, Allen A C, Graham S, and King W P 2006 Molding ceramic microstructures on flat and curved surfaces with and without embedded carbon nanotubes. Journal of Micromechanics and Microengineering. 16(12): p. 2554-2563.
Quere D 2005 Non-sticking drops. Reports on Progress in Physics. 68(11): p. 2495-2532.
Quere D and Reyssat M 2008 Non-adhesive lotus and other hydrophobic materials. Philosophical Transactions of the Royal Society a-Mathematical Physical and Engineering Sciences. 366(1870): p. 1539-1556.
U.S. Pat. Nos. 5,055,163; 5,512,219; 6,190,594; 6,375,776; 7,141,812; 7,144,241; 7,410,606; 7,411,204; 7,462,852.
U.S. Patent Application Publications 2003/0187170; 2006/0162896; 2008/0199663; 2009/0046362.
International Patent Application Publications WO 97/13633; WO 2007/064803; WO 2008/098030.

### STATEMENTS REGARDING INCORPORATION BY REFERENCE AND VARIATIONS

All references throughout this application, for example patent documents including issued or granted patents or equivalents, patent application publications, and non-patent literature documents or other source material are hereby incorporated by reference herein in their entireties, as though individually incorporated by reference, to the extent each reference is at least partially not inconsistent with the disclosure in this application (for example, a reference that is partially inconsistent is incorporated by reference except for the partially inconsistent portion of the reference).

All patents and publications mentioned in the specification are indicative of the levels of skill of those skilled in the art to which the invention pertains. References cited herein are incorporated by reference herein in their entirety to indicate the state of the art, in some cases as of their filing date, and it is intended that this information can be employed herein, if needed, to exclude (for example, to disclaim) specific embodiments that are in the prior art. For example, when a compound is claimed, it should be understood that compounds known in the prior art, including certain compounds disclosed in the references disclosed herein (particularly in referenced patent documents), are not intended to be included in the claim.

When a group of substituents is disclosed herein, it is understood that all individual members of those groups and all subgroups and classes that can be formed using the substituents are disclosed separately. When a Markush group or other grouping is used herein, all individual members of the group and all combinations and subcombinations possible of the group are intended to be individually included in the disclosure.

Every formulation or combination of components described or exemplified can be used to practice the invention, unless otherwise stated. Specific names of materials are intended to be exemplary, as it is known that one of ordinary skill in the art can name the same material differently. One of ordinary skill in the art will appreciate that methods, device elements, starting materials, and synthetic methods other than those specifically exemplified can be employed in the practice of the invention without resort to undue experimentation. All art-known functional equivalents, of any such methods, device elements, starting materials, and synthetic methods are intended to be included in this invention. Whenever a range is given in the specification, for example, a temperature range, a time range, or a composition range, all intermediate ranges and subranges, as well as all individual values included in the ranges given are intended to be included in the disclosure.

As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the claim element. As used herein, “consisting essentially of” does not exclude materials or steps that do not materially affect the basic and novel characteristics of the claim. Any recitation herein of the term “comprising”, particularly in a description of components of a composition or in a description of elements of a device, is understood to encompass those compositions and methods consisting essentially of and consisting of the recited components or elements. The invention illustratively described herein suitably may be practiced in the absence of any element or elements, limitation or limitations which is not specifically disclosed herein.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims.

We claim:

1. A method of making a microstructured metal object, the method comprising the steps of:
fabricating a microstructured flexible mold having a preselected pattern of microfeatures on at least a portion of a surface of the microstructured flexible mold;
applying a liquid metal to the microstructured flexible mold, wherein the liquid metal has a melting point selected within the range of 35 to 650° C.;
cooling the liquid metal, thereby replicating at least a portion of the preselected pattern of microfeatures in solid metal; and
removing the microstructured flexible mold from the solid metal, thereby making a microstructured metal object.

2. The method of claim 1, further comprising a step of treating at least a portion of the microfeatures of the microstructured flexible mold.

3. The method of claim 2, wherein the step of treating comprises applying napfin, paraffin wax, a polysiloxane, a synthetic wax, mineral oil, Teflon, a fluoropolymer, a silane, a fluorosilane, a thiol, a surfactant or any combination of these to at least a portion of the microfeatures of the microstructured flexible mold.

4. The method of claim 2, wherein the step of treating comprises exposing at least a portion of the microfeatures of the microstructured flexible mold to an oxygen plasma, UV radiation or both an oxygen plasma and UV radiation.

5. The method of claim 2, wherein the step of treating increases interaction between the liquid metal and the microstructured flexible mold or reduces the interfacial tension between the liquid metal and the microstructured flexible mold.

6. The method of claim 1, further comprising a step of deforming at least a portion of the microstructured flexible mold, wherein at least a portion of the preselected pattern of microfeatures are located on a curved surface of the microstructured flexible mold.

7. The method of claim 1, wherein at least a portion of the microstructured flexible mold is in a bent, flexed, compressed, stretched, expanded and/or strained configuration.

8. The method of claim 1, further comprising a step of applying pressure between the liquid metal and microstructured flexible mold.

9. The method of claim 8, wherein a contact angle between the liquid metal and the microstructured flexible mold is greater than 90°.

10. The method of claim 1, further comprising a step of placing the liquid metal and the microstructured flexible mold under vacuum.

11. The method of claim 10, wherein the liquid metal has a viscosity of less than 1000000 cSt.

12. The method of claim 1, further comprising a step of placing the liquid metal and the microstructured flexible mold under a pressure greater than ambient pressure.

13. The method of claim 12, wherein the liquid metal has a viscosity of greater than 1000000 cSt.

14. The method of claim 1, wherein the solid metal has a yield strength selected within the range of 1 to 1000 psi or 1000 to 16000 psi.

15. The method of claim 1, further comprising the step of heating the microstructured flexible mold to a temperature above the melting point of the metal.

16. The method of claim 1, wherein the microfeatures of the microstructured flexible mold are replicated in the microstructured metal object with high fidelity.

17. The method of claim 1, wherein the preselected pattern of microfeatures is replicated in the microstructured metal object with high fidelity.

18. The method of claim 1, wherein the microstructured flexible mold comprises a polymer.

19. The method of claim 18, wherein the polymer is selected from the group consisting of: a rubber, a silicone rubber, a polysiloxanes, PDMS and any combination of these.

20. The method of claim 1, wherein the microstructured flexible mold comprises a composite.

21. The method of claim 20, wherein the microstructured flexible mold comprises carbon nanotubes or a material having a Young's modulus selected over the range of 300 kPa to 1000 GPa.

22. The method of claim 1, wherein the metal comprises lead, tin, bismuth, cadmium, indium, antimony, iron, nickel, cobalt, zinc, aluminum, gold, silver, copper, platinum, tungsten, tantalum or any combination or alloy of these.

23. The method of claim 1, wherein the metal comprises an alloy selected from the group consisting of CerroMatrix® (Bismuth-Lead-Tin-Antimony alloy), CerroCast® (Bismuth-Tin alloy), CerroTru® (Bismuth-Tin alloy), CerroBase® (Bismuth-Lead alloy), CerroLow® 136 (Bismuth-Lead-Tin-Indium alloy), CerroBend® (Bismuth-Lead-Tin-Cadmium alloy), CerroSafe® (Bismuth-Lead-Tin-Cadmium alloy), CerroLow® 117 (Bismuth-Lead-Tin-Cadmium-Indium alloy), CerroLow® 147 (Bismuth-Lead-Tin-Cadmium-Indium alloy) and any combination of these.

24. The method of claim 1, wherein the microfeatures have dimensions selected over the range of 10 nm to 500 μm.

25. The method of claim 1, wherein the microfeatures have a height:width aspect ratio selected over the range of 1:1 to 10:1.

26. The method of claim 1, wherein the preselected pattern of microfeatures is a regular array of microfeatures.

27. The method of claim 1, wherein the preselected pattern of microfeatures has a pitch selected over the range of 10 nm to 500 μm.

28. The method of claim 1, further comprising the steps of
applying a second liquid metal to the microstructured flexible mold, wherein the second liquid metal has a melting point selected within the range of 35 to 650° C.;
cooling the liquid metal, thereby replicating at least a portion of the preselected pattern of microfeatures in a second solid metal; and
removing the microstructured flexible mold from the second solid metal, thereby making an additional microstructured metal object.

29. The method of claim 1, wherein the microstructured metal object is an embossing tool.

30. The method of claim 29, wherein the embossing tool is a roller, a cylindrical embossing tool or a spherical embossing tool.

31. The method of claim 1, wherein the microstructured flexible mold is a roller.

32. The method of claim 1, wherein the microstructured flexible mold is a conveyor.

33. The method of claim 1, wherein the microstructured metal object is a microstructured metal sheet.

34. The method of claim 1, wherein the step of fabricating a microstructured flexible mold comprises the steps of:
providing a macro master mold; and
providing a microstructured polymer having a preselected pattern of microfeatures to at least a portion of the surface of the macro master mold.

35. The method of claim 34, wherein the microstructured polymer comprises a lithographically patterned flexible polymer.

36. The method of claim 34, wherein the microstructured polymer comprises a flexible polymer cast or molded from a lithographically patterned substrate.

37. The method of claim 1, wherein the step of fabricating a microstructured flexible mold comprises the steps of:
providing a semiconductor wafer;
patterning the semiconductor wafer with a preselected pattern of microfeatures;
molding an uncured flexible polymer to the patterned semiconductor wafer;
curing the polymer, thereby forming a microstructured flexible polymer having the preselected pattern of microfeatures; and
removing the microstructured flexible polymer from the patterned semiconductor wafer, thereby forming the microstructured flexible mold.

38. The method of claim 37, wherein the patterning step comprises patterning the semiconductor wafer using an anisotropic etching method.

39. The method of claim 37, wherein the patterning step comprises patterning the semiconductor wafer using a method selected from the group consisting of: photolithography, laser ablation, laser patterning, laser machining, x-ray lithography, e-beam lithography, nano-imprint lithography and any combination of these.

40. The method of claim 37, wherein the patterned semiconductor wafer comprises a unitary body.

41. The method of claim 37, wherein the step of fabricating a microstructured flexible mold further comprises a step of treating the at least a portion of the patterned semiconductor wafer with a composition selected from the group consisting of: napfin, paraffin wax, a polysiloxane, a synthetic wax, mineral oil, Teflon, a fluoropolymer, a silane, a fluorosilane, a thiol or any combination of these.

42. A method of making a microstructured epoxy object, the method comprising the steps of:
fabricating a microstructured flexible mold having a preselected pattern of microfeatures on at least a portion of a surface of the microstructured flexible mold;
applying a liquid thermoset polymer to the microstructured flexible mold;
curing the liquid thermoset polymer, thereby replicating at least a portion of the preselected pattern of microfeatures in cured epoxy; and
removing the microstructured flexible mold from the cured epoxy, thereby making a microstructured epoxy object.

43. The method of claim 42, further comprising a step of treating at least a portion of the microfeatures of the microstructured flexible mold.

44. The method of claim 43, wherein the step of treating comprises applying napfin, paraffin wax, a polysiloxane, a synthetic wax, mineral oil, Teflon, a fluoropolymer, a silane, a fluorosilane, a thiol or any combination of these to at least a portion of the microfeatures of the microstructured flexible mold.

45. The method of claim 43, wherein the step of treating comprises exposing at least a portion of the microfeatures of the microstructured flexible mold to an oxygen plasma, exposing at least a portion of the microfeatures to UV radiation, applying a surfactant to at least a portion of the microfeatures or any combination of these.

46. The method of claim 42, further comprising deforming at least a portion of the microstructured flexible mold, wherein at least a portion of the preselected pattern of microfeatures are located on a curved surface of the microstructured flexible mold.

47. The method of claim 42, wherein at least a portion of the microstructured flexible mold is in a bent, flexed, compressed, stretched, expanded and/or strained configuration.

48. The method of claim 42, further comprising the step of applying pressure between the liquid thermoset polymer and microstructured flexible mold.

49. The method of claim 42, further comprising the step of placing the liquid thermoset polymer and the microstructured flexible mold under vacuum.

50. The method of claim 49, further comprising the step of releasing the vacuum before the curing step is finished.

51. The method of claim 42, wherein the thermoset polymer comprises a two-part thermoset polymer mixture.

52. The method of claim 42, wherein the thermoset polymer comprises a polyamide, a polyimide, a polyester, a phenol-formaldehyde, a urea-formaldehyde, melamine, polyvinylchloride, a polyurethane, a silicone rubber or any combination of these.

53. The method of claim 42, wherein the step of fabricating a microstructured flexible mold comprises the steps of:
providing a semiconductor wafer;
patterning the semiconductor wafer with a preselected pattern of microfeatures;
molding an uncured flexible polymer to the patterned semiconductor wafer;
curing the polymer, thereby forming a microstructured flexible polymer having the preselected pattern of microfeatures;
removing the microstructured flexible polymer from the patterned semiconductor wafer, thereby forming the microstructured flexible mold.

54. A method of making a microstructured film, the method comprising the steps of:
fabricating a microstructured flexible mold having a preselected pattern of microfeatures on at least a portion of a surface of the microstructured flexible mold;
applying a liquid metal to the microstructured flexible mold, wherein the liquid metal has a melting point selected within the range of 35 to 650° C.;
cooling the liquid metal, thereby replicating at least a portion of the preselected pattern of microfeatures in solid metal; and
removing the microstructured flexible mold from the solid metal, thereby making a microstructured embossing tool having the preselected pattern of microfeature on at least a portion of a surface of the microstructured metal embossing tool;
providing a film; and
embossing the film with the microstructured metal embossing tool, thereby making a microstructured film.

55. The method of claim 54, further comprising a step of treating at least a portion of the microfeatures of the microstructured flexible mold.

56. The method of claim 55, wherein the step of treating comprises applying napfin, paraffin wax, a polysiloxane, a synthetic wax, mineral oil, Teflon, a fluoropolymer, a silane, a fluorosilane, a thiol or any combination of these to at least a portion of the microfeatures of the microstructured flexible mold.

57. The method of claim 55, wherein the step of treating comprises exposing at least a portion of the microfeatures of the microstructured flexible mold to an oxygen plasma, exposing at least a portion of the microfeatures to UV radiation, applying a surfactant to at least a portion of the microfeatures or any combination of these.

58. The method of claim 54, wherein at least a portion of the preselected pattern of microfeatures of the microstructured metal embossing tool are replicated in the microstructured film with high fidelity.

59. The method of claim 54, wherein at least a portion of the preselected pattern of microfeatures of the microstructured flexible mold are replicated in the microstructured embossing tool with high fidelity.

60. The method of claim 54, wherein at least a portion of the microstructured flexible mold is in a bent, flexed, compressed, stretched, expanded and/or strained configuration.

61. The method of claim 54, wherein the film comprises a polymer.

62. The method of claim 61, wherein the polymer is selected from the group consisting of: a rubber, a silicone rubber, a polysiloxanes, PDMS and any combination of these.

63. The method of claim 54, wherein the step of fabricating a microstructured flexible mold comprises the steps of:
providing a semiconductor wafer;
patterning the semiconductor wafer with a preselected pattern of microfeatures;
molding or casting an uncured flexible polymer to the patterned semiconductor wafer;
curing the polymer, thereby forming a microstructured flexible polymer having the preselected pattern of microfeatures; and
removing the microstructured flexible polymer from the patterned semiconductor wafer, thereby forming the microstructured flexible mold.
